(19) United States
(12) Patent Application Publication
(10) Pub. No.: US 2010/0191419 A1
(43) Pub. Date: Jul. 29, 2010

(54) Combination Instrument for Displaying Operating States

(75) Inventor: Andreas Habeney, Liederbach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/677,759

(22) PCT Filed: Sep. 8, 2008
(86) PCT No.: PCT/EP08/61850

§ 371 Date: Mar. 11, 2010

(30) Foreign Application Priority Data
Sep. 11, 2007 (DE) 10 2007 043 207.2

(51) Int. Cl. G06F 19/00; F21S 8/10

(52) U.S. Cl. 701/36; 362/543; 362/545

(57) ABSTRACT

A combination instrument for displaying operating states of a motor vehicle. The combination instrument includes a three-dimensional model of an object symbolizing an operating state of the motor vehicle. The three-dimensional model of the object is designed to be at least partially translucent, and the three-dimensional model of the object is designed such that it can be illuminated by an illumination device.

### PRIORITY CLAIM

This is a U.S. national stage of application No. PCT/EP2008/061850, filed on Sep. 8, 2008, which claims priority to the German Application No.: 10 2007 043 207.2, Filed: Sep. 11, 2007; the contents of both which are incorporated here by reference.

### BACKGROUND OF THE INVENTION

1. Field of the Invention

The invention relates to a combination instrument for displaying operating states.

2. Prior Art

It is known to provide displays that are a plurality of displays that can be displayed by a single instrument. Thus, for example, it is known to use a speedometer or tachometer to display the current traveling speed of a motor vehicle, in the case of which additional displays such as, for example, a trip-mileage counter, a kilometer counter or indicator symbols in the form of pictograms for specific operating states such as, for example, the function of a flasher device, an indication of the operation of another illumination device, an indication of ineffective states of other motor vehicle components such as, for example, brakes, airbags, generators, or cooling devices. These indications are only poorly perceptible in part.

### SUMMARY OF THE INVENTION

An object of the present invention is therefore to specify a combination instrument in which at least one such indicator element is more effectively perceptible. This object is achieved by a combination instrument that has a three-dimensional simulation of an object which symbolizes an operating state of the motor vehicle, that the three-dimensional simulation of the object is designed to be at least partially translucent, and that the three-dimensional simulation of the object is designed such that it can be illuminated. The result of this is that this three-dimensional design stands out more effectively from the background of the combination instrument, and is essentially more effectively perceptible in the case of its illumination.

The perceptibility of the three-dimensional simulation of the object is further increased when the combination instrument has a first display plane with a dial and/or display symbols, and from the direction of view of an observer of the combination instrument the three-dimensional simulation of the object is arranged at least partially in front of the first display plane, and there is an interspace lying between the first display plane and the three-dimensional display of the object from the direction of view of an observer. As a result of this interspace lying between the simulation and the first display plane a visible gap is located between the first display plane and the three-dimensional simulation. The three-dimensional simulation is further removed from the first display plane, and can therefore be more effectively distinguished and perceived.

By way of example, the three-dimensional display of a gasoline pump symbolizes that the fuel reservoir in the tank of the motor vehicle is running low, and indicates to the vehicle driver that he should fill up the fuel reservoir of the motor vehicle so that he is not stranded and thus suffers discomfort or even encounters a dangerous situation should he, for example, be stranded on a freeway.

The three-dimensional simulation of the object can be illuminated in a plurality of colors by an illumination device. It is possible to display a plurality of states of the operating state to be monitored, for example a gasoline pump illuminated in green can indicate that a large fuel reservoir is still present, and a gasoline pump illuminated in red can indicate that the tank reserve should be renewed. The illumination device is particularly energy-saving and long-lasting when it has at least one light-emitting diode. When the illumination device consists of a red, green and blue light-emitting diode, the simulation can be illuminated in all available colors by mixing the available colors. The design is particularly simple when use is made of an RGB light-emitting diode in which red, green and blue light-emitting diodes are integrated. A virtually quasi-analog display can be implemented owing to the multi-chromaticity. Thus, for example, a green gasoline pump can symbolize that the fuel reservoir is full or virtually full, then switch to a blue color, for example, with a decreasing fuel reservoir, and further assume a yellow state before a red state, before finally a red display then indicates to the vehicle driver that filling up should be done straight away. When the fuel reservoir has been reduced to a low level, it is possible to illuminate the simulation of the object in a red color with interruptions such that flashing appears. It is also possible to implement this flashing not only by switching the red color on and off but by providing illumination alternately in red and yellow or red and blue, in which case the time in which the simulation is illuminated in red is advantageously longer than the illumination time in the other color. Consideration is given to the gasoline pump already mentioned above, but also to a thermometer, a symbolized brake, a headlamp, an oil can, or a tire cross section. Here, the thermometer symbolizes the temperatures of operation of the engine, for example those of the engine oil or the engine coolant. A symbolized brake indicates possible brake defects. For example, a brake illuminated in red displays an absolute defect, and a brake illuminated in yellow indicates that the brakes should be inspected as soon as possible, for example that the brake liners should be replaced. A headlamp symbolizes the function of a headlamp, in which case a single simulation of a headlamp is used, for example, to display the function of the high-beam headlamp with blue illumination, and the function of the rear fog lights with green illumination. An oil can indicate an oil pressure or oil reserve of the engine, for example an oil can illuminated in yellow can indicate to the vehicle driver to fill up the engine oil reserve, and an oil can illuminated in red can indicate to the vehicle driver that the engine oil pressure is so low that the operation of the engine should be ceased at once. A tire cross section can indicate an air pressure in the tires of the motor vehicle, for example a tire illuminated in red indicates that the air pressure is too low, and a tire illuminated in green that the air pressure of the tires is correct.

### BRIEF DESCRIPTION OF DRAWINGS

The invention is explained in more detail below with the aid of the figures, in which:

FIG. 1 is a first image of an exemplary embodiment of an inventive combination instrument according to one embodiment of the invention;

FIG. 2 is a cross-section through the combination instrument from FIG. 1;

FIG. 3 is a plan view of a second exemplary embodiment of the inventive combination instrument;

FIG. 4 is a cross section through the combination instrument from FIG. 3; and

FIG. 5 view of a further exemplary embodiment of the invention.

### DETAILED DESCRIPTION OF THE DRAWINGS

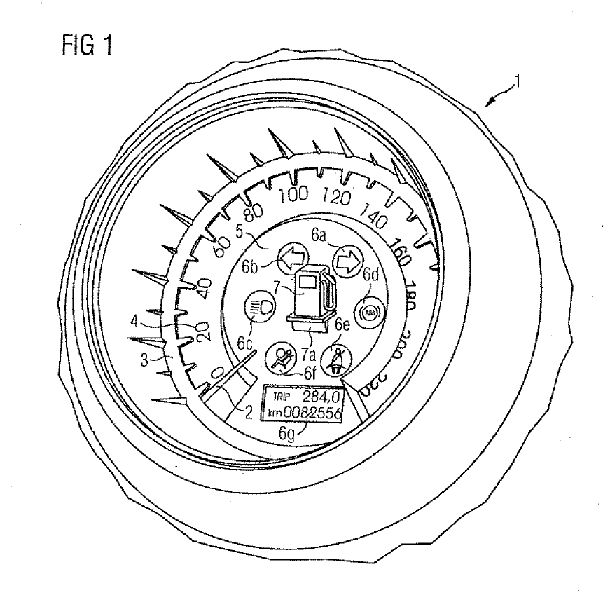

FIG. 1 is a combination instrument 1 having a pointer tip 2, a scale 3, scale numbers 4, a first display plane 5 with display symbols 6a to 6f, and a kilometer counter 6g, a three-dimensional simulation 7 of an object with a base 7a, and a second display plane 8. The scale 3 with the scale numbers 4 is implemented in the second display plane 8 by being printed onto a transparent partial ring such that the scale 3 with the scale numbers 4 is located in front of the pointer tip 2 from the direction of view of an observer. Of course, it is also possible to arrange the scale 3 and the scale numbers 4 in the first display plane 5, and thus to dispense with the second display plane 8. The three-dimensional simulation 7 of the object, here a gasoline pump, is arranged on the base 7a and projects away from the first display plane 5 such that an interspace is located between the first display plane 5 and the three-dimensional simulation 7. This substantially increases the perceptibility of the three-dimensional simulation 7. By way of example, the three-dimensional simulation 7 can be illuminated in a plurality of colors by an RGB LED, and thus be capable of illumination in green given a full fuel tank, in blue given a fuel tank ⅔ full, yellow given a fuel tank ⅓ full, and red given a reserve still just present in the reservoir. The vehicle driver thus quickly obtains an impression of the amount of fuel still available.

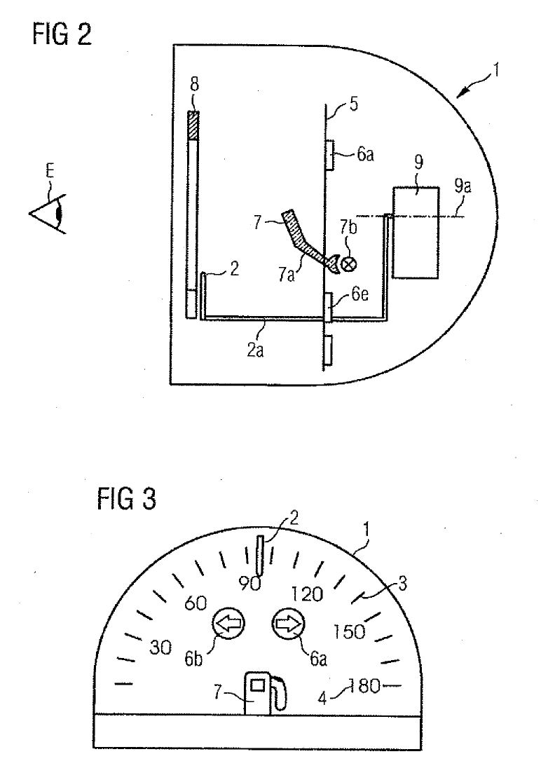

In addition to the components indicated in FIG. 1, a pointer 2a, an illumination device 7b and a measuring element 9 can be seen in FIG. 2. The illumination device 7b transmits its light through the base 7a into the three-dimensional simulation 7. The three-dimensional simulation 7 thereby emits light. It is further to be seen that the three-dimensional simulation 7 is arranged remote from the first display plane 5. The pointer 2a is driven by the measuring element 9 and supports the pointer tip 2. It can rotate about the axis 9a of the measuring element. Thus, the speed at which the motor vehicle is currently traveling can be read off on the scale 3 with the scale numbers 4 by an appropriate rotation of the pointer 2a with the pointer tip 2. The base 7a is advantageously designed such that it conducts light in its core and has an opaque outer surface such that it only conducts light but does not itself output any light to the surroundings.

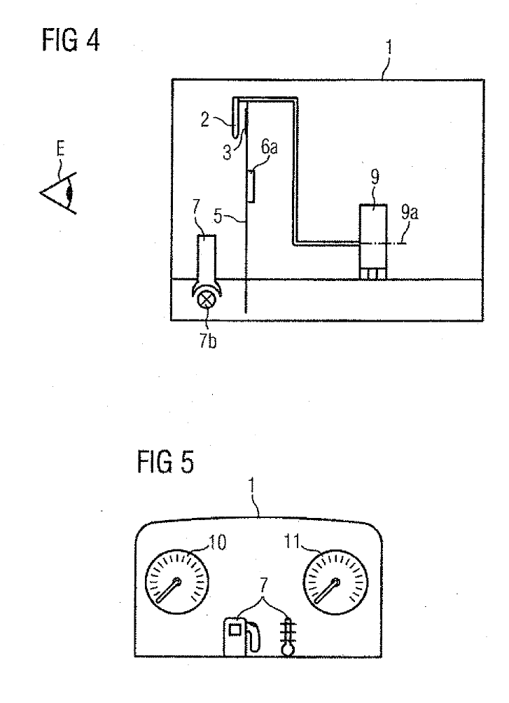

In FIG. 3, a further exemplary embodiment of a combination instrument 1 in turn has a scale 3 with scale numbers 4, display symbols 6a, 6b and a three-dimensional simulation 7 of an object. By contrast with the exemplary embodiment in FIGS. 1 and 2, in the second exemplary embodiment of FIGS. 3 and 4 the three-dimensional simulation 7 of an object is arranged completely in front of the first display plane 5 such that the interspace present between the first display plane 5 and the three-dimensional simulation 7 is yet more effectively perceptible, and the three-dimensional simulation 7 is yet more effectively perceptible.

In addition, an eye E of an observer is further illustrated in FIG. 4. A further difference from the first exemplary embodiment consists in that the scale 3 and the scale numbers 4 are arranged in the first display plane 5 such that the design outlay for the combination instrument is reduced.

Finally, FIG. 5 is a combination instrument with two analog displays in the form of a tachometer 10 and a revolution counter 11, between which three-dimensional simulations 7 in the form in one case of a gasoline pump and in the form in another case of a thermometer are displayed. By way of example, the thermometer can indicate a correct or incorrect operating temperature of the motor vehicle engine. For example, it is possible here to mark a cold engine by the thermometer illuminated in blue, to display an engine at an optimum operating temperature by a green illumination of the thermometer, and to display an overheated engine by a thermometer illuminated in red. Thus, the vehicle driver easily obtains an indication of the operating state, being, firstly, warned not to load a cold engine unnecessarily, and prompted in the case of an overheating engine to initiate appropriate countermeasures.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A combination instrument for displaying operating states of a motor vehicle, comprising:
an at least partially translucent three-dimensional simulation of an object that symbolizes an operating state of the motor vehicle; and
an illumination device configured to illuminate the three-dimensional simulation of the object.

11. The combination instrument as claimed in claim 10, wherein the combination instrument comprises:
a first display plane having at least one of scales and display symbols,
wherein from a direction of view of an observer of the combination instrument, the three-dimensional simulation of the object is arranged at least partially in front of the first display plane such that a space is located between the first display plane and at least a portion of the three-dimensional simulation of the object.

12. The combination instrument as claimed in claim 10, wherein the three-dimensional simulation of the object is configured to be illuminated in a plurality of colors by the illumination device.

13. The combination instrument as claimed in claim 10, wherein the illumination device comprises at least one light-emitting diode.

14. The combination instrument as claimed in claim 13, wherein the illumination device comprises a red, a blue, and a green light-emitting diode.

15. The combination instrument as claimed in claim 13, wherein the illumination device comprises an RGB light-emitting diode.

16. The combination instrument as claimed in claim 12, wherein the illumination device illuminates the three-dimensional simulation of an object in different colors depending on the operating state to be displayed.

17. The combination instrument as claimed in claim 10, wherein the illumination device illuminates the simulation of the object with interruptions in the case of a particular operating state.

18. The combination instrument as claimed in claim 10, wherein the three-dimensional simulation of the object displays at least one of a gasoline pump, a thermometer, a symbolized brake, a headlamp, an oil can, and a tire cross section.

19. The combination instrument as claimed in claim 12, wherein the illumination device comprises at least one light-emitting diode.

20. The combination instrument as claimed in claim 19, wherein the illumination device comprises a red, a blue and a green light-emitting diode.

21. The combination instrument as claimed in claim 19, wherein the illumination device comprises an RGB light-emitting diode.

22. The combination instrument as claimed in claim 21, wherein the illumination device illuminates the three-dimensional simulation of an object in different colors depending on the operating state to be displayed.

23. The combination instrument as claimed in claim 22, wherein the illumination device illuminates the simulation of the object with interruptions in the case of a particular operating state.
